(19) United States
(12) Patent Application Publication
(10) Pub. No.: US 2018/0118973 A1
(43) Pub. Date: May 3, 2018

(54) METHOD FOR PREPARING SILICONE-TREATED FILMS OF POLYETHYLENE TEREPHTHALATE (PET)

(71) Applicant: SILICONATURE S.P.A., Godega Di Sant'Urbano (IT)

(72) Inventor: Lorenzo DE ZAN, Sacile (IT)

(21) Appl. No.: 15/566,810

(22) PCT Filed: Dec. 30, 2015
(86) PCT No.: PCT/EP2015/081421

§ 371 Date: Oct. 16, 2017

(30) Foreign Application Priority Data
Apr. 16, 2015 (IT) MI2015A000550

(51) Int. Cl. C09D 183/04; C08L 83/04; C08G 77/20; C08J 5/18

(52) U.S. Cl. CPC C09D 183/04; C08J 5/18; C08G 77/20; C08L 83/04

(57) ABSTRACT

A method for preparing silicone-treated films of PET in which the silicone treatment step occurs simultaneously with the extrusion of the film (“in-line”).

### TECHNICAL FIELD

The present disclosure relates to a method for providing silicone-treated films of polyethylene terephthalate (PET). The silicone treatment of films of PET includes a method whereby the films are spread with a silicone mixture in order to create a layer of silicone polymer which adheres to the surface of the films Silicone-treated PET films are widely used in many fields of application, and in particular they act as a support for releasing adhesives of various types, such as labels and adhesive bands. In particular, silicone-treated films possess properties of controlled-release separation from the adhesives to which they are made to adhere, without altering the chemical-physical properties of the adhesives themselves.

### BACKGROUND

Currently, the production of silicone-treated PET films occurs by way of two methods of extrusion: the “in-line” method, in which the spreading of the mixture of silicone compounds on the film occurs simultaneously with the actual extrusion of the film, and the “off-line” method, in which the spreading of the mixture of silicones on the film occurs at the end of the extrusion of the film

In detail, the “in-line” production of silicone-treated PET films comprises the following steps:

(i) longitudinally stretching a casting of melted PET, in order to obtain a film stretched in a longitudinal direction;

(ii) cooling the film obtained in step (i) down to ambient temperature;

(iii) spreading a mixture of silicones on the film obtained in step (ii);

(iv) laterally stretching (at right angles to the direction of the longitudinal stretching) the film obtained in step (iii), in order to obtain a film stretched in the two directions;

(v) bringing the film obtained in step (iv) to temperatures comprised between 170° C. and 280° C. for a time comprised between 3 and 30 seconds;

(vi) cooling the film obtained in step (v) down to ambient temperature.

The “off-line” production of silicone-treated PET films comprises the following steps:

(i) longitudinally stretching a casting of melted PET, in order to obtain a film stretched in a longitudinal direction;

(ii) laterally stretching (at right angles to the direction of the longitudinal stretching) the film obtained in step (i), in order to obtain a film stretched in the two directions;

(iii) bringing the film obtained in step (ii) to temperatures comprised between 170° C. and 280° C. for a time comprised between 3 and 30 seconds;

(iv) cooling the film obtained in step (iii) down to ambient temperature;

(v) spreading a mixture of silicones on the film obtained in step (iv).

The step of heating the PET film to temperatures comprised between 170° C. and 280° C. for 3-30 seconds, carried out at the end of the lateral stretching both in the “in-line” method and in the “off-line” method, serves to enable the crystallization of the PET and its consequent thermal stabilization.

The “in-line” method is obviously more practical with respect to the “off-line” method, since carrying out the silicone treatment simultaneously with the extrusion of the PET film allows a better operating practicality, together with a saving of time.

Furthermore, the application of the silicone layer prior to the thermal stabilization of the PET film makes it possible to obtain a better adhesion of the silicone layer on the PET surface, and therefore a better resistance of the siliconized film.

For the production of silicone-treated PET films, both “in-line” and “off-line”, the use is known of aqueous mixtures that comprise silicones, which are spread on the PET films

However, aqueous mixtures suffer the disadvantage of poorly solubilizing silicones, which are hydrophobic molecules; in fact, only a few kinds of silicones are capable of solubilizing in an aqueous medium.

In order to mediate the hydrophobic nature of the silicones and the hydrophilic nature of the aqueous medium, it is known to add additives such as ionic or non-ionic surfactants and wetting agents to the silicone/aqueous mixtures, for example glycols and esters. These additives confer greater stability to the emulsion of silicones in an aqueous medium and they ensure a fair wettability and spreading of such emulsion onto PET films

Such additives are therefore essential for the formulation of aqueous mixtures of silicones. However, owing to their chemical nature, such additives are incapable, completely or at least partially, of undergoing a polymerization that would reduce their chemical activity in the finished product.

Furthermore, since they are amphiphile molecules, the additives are chemically compatible both with the silicones, to which they bond with the apolar portions, and with the adhesives with which the silicone-treated PET films are coupled.

This causes the initiation of chemical interactions at the silicone-adhesive interface, which give rise to unwanted effects such as the anchoring of the adhesive to the layer of silicone and/or an increase in the force to release the silicone from the adhesive.

These effects cause an instability in the silicone-adhesive system, altering its chemical-physical properties over time.

On the other hand, since silicones are soluble in an apolar organic medium, the use of silicone mixtures based on apolar organic solvents appears to be evidently advantageous.

However, mixtures based on apolar organic solvents can only be used in the “off-line” method, since such solvents must not be present when the PET film is being subjected to lateral stretching.

In fact the presence of such solvents on the surface of the film, at the temperature at which the lateral stretching occurs (80-110° C.), would create a serious risk of explosion.

Therefore, the use of silicone mixtures based on apolar organic solvents is not currently possible for the “in-line” production of silicone-treated PET films, but is limited to the “off-line” production which, as noted previously, is more inconvenient and disadvantageous.

### SUMMARY

The aim of the present disclosure is therefore to devise a method of providing silicone-treated PET films which solves the above mentioned technical problems, while removing the drawbacks and overcoming the limitations of the known art.

Within this aim, the disclosure provides a method of providing silicone-treated PET films with the “in-line” approach, using silicone mixtures based on apolar organic solvents.

The disclosure also provides a method of providing silicone-treated PET films with the “in-line” approach, while preventing the risk of explosion linked to the presence of apolar organic solvents during the step of lateral stretching.

The present disclosure further provides a method of providing silicone-treated PET films with the “in-line” approach, using materials with a chemical nature that is compatible with the silicones, so as to preserve the physical variability of the final product which is associated with the various types of silicones that can be used.

The disclosure also provides a method of providing silicone-treated PET films with the “in-line” approach, in which the controlled-release separating effect can be modulated for adhesives of different chemical natures and compositions.

In essence, the present disclosure sets out to provide a method that combines the advantages of the “in-line” and “off-line” approaches, in particular the operating practicality of the first, and the possibility offered by the second of using silicone mixtures based on apolar organic solvents.

The disclosure also provides a method that is highly reliable, easy to implement and low cost, and which makes use of the usual conventional systems.

These features and advantages which will become better apparent hereinafter are achieved by providing a method for preparing silicone-treated films of polyethylene terephthalate (PET), in which the silicone treatment occurs simultaneously with the extrusion of the films, which comprises the steps of:

(i) longitudinal stretching of a casting of melted PET;

(ii) cooling to ambient temperature of the film obtained in step (i);

(iii) spreading, on the cooled film, a silicone mixture;

(iv) heating the PET film coated with the silicone mixture to a temperature comprised between 20° C. and 70° C. for a time comprised between 1 and 15 seconds;

(v) lateral stretching of the PET film obtained in step (iv);

(vi) heating of the film obtained in step (v) to temperatures comprised between 170° C. and 280° C. for a time comprised between 3 and 30 seconds;

(vii) cooling of the film obtained in step (vi) down to ambient temperature;

wherein the silicone mixture comprises:

(a) from 1% to 50% by weight on the total weight of the mixture, of one or more monomers and/or one or more silicone prepolymers;

(b) from 50% to 95% by weight on the total weight of the mixture, of one or more apolar organic solvents having a boiling point comprised between 50° C. and 120° C. and a vapor pressure comprised between 2 and 30 kPa, measured at 20° C.;

(c) from 0.1% to 5% by weight on the total weight of the mixture, of one or more cross-linking agents; and

(d) from 40 to 80 ppm of catalytic platinum (II), in which said catalytic platinum (II) is in complexed form.

In the present disclosure, the terms “silicone mixture”, “mixture of silicones”, and “mixture that comprises silicones” are used to mean a solution that comprises monomers and/or silicone prepolymers dissolved in one or more apolar organic solvents.

On the other hand, with reference to the known art, the term “aqueous mixture” is used to mean a solution that comprises monomers and/or silicone prepolymers dissolved in an aqueous medium.

In the context of the present disclosure, furthermore, the terms “longitudinal stretching” (or “MDO stretching”) and “lateral stretching” (or “TDO stretching” or “transverse stretching”) are used with the meaning commonly attributed to them and known to the person skilled in the art; the longitudinal direction and the lateral (or transverse) direction are perpendicular to each other.

Further characteristics and advantages of the disclosure will become better apparent from the detailed description that follows of a preferred, but not exclusive, embodiment of the method according to the disclosure and of the silicone mixture used for the silicone treatment of PET films

As mentioned, the silicone mixture used in the method of the disclosure comprises:

(a) one or more monomers and/or one or more silicone prepolymers;

(b) one or more apolar organic solvents having a boiling point comprised between 50° C. and 120° C. and a vapor pressure comprised between 2 and 30 kPa, measured at 20° C.;

(c) one or more cross-linking agents; and

(d) catalytic platinum (II) in complexed form.

As mentioned previously, the use of apolar organic solvents makes it possible to dissolve silicones (in the form of monomers and/or silicone prepolymers) of different chemical natures.

By way of example, among the silicones that can be used in the disclosure we can cite poly-methyl-siloxanes, poly-dimethyl-siloxanes and multiples thereof, having side chains of length comprised between 1 and 10 carbon atoms, preferably comprised between 1 and 6 carbon atoms.

It is further preferable to use silicones that have one or more vinyl groups on the side chains.

In a preferred embodiment of the present disclosure, the monomers and/or silicone prepolymers can be present in the silicone mixture in a quantity comprised between 5% and 30% by weight on the total weight of the mixture.

More preferably, the monomers and/or silicone prepolymers can be present in the silicone mixture in a quantity comprised between 10% and 25% by weight on the total weight of the mixture.

The monomers and/or the silicone prepolymers polymerize in situ on the PET film, forming a layer of silicone polymer, adhering to the PET surface.

The polymerization occurs by way of an addition reaction, in which, as is known, the vinyl end groups present in varying numbers on the monomers and/or silicone prepolymers bond the SiH groups present on the chains of the cross-linking agents.

The cross-linking agents (commonly also known as “cross-linkers”) are molecules capable of forming bonds between different linear chains of the silicones (or between different points of the same chain), with the formation of a polymer having a “net” structure.

The nature of the cross-linking agents, which is variable based on the type of monomers and/or silicone prepolymers used, is known to the skilled person in the silicone polymers sector.

As examples of cross-linking agents, we can cite methylsilane and multiple structures thereof.

In an embodiment of the disclosure, it is possible to use poorly-reactive cross-linkers, i.e., as is known to the person skilled in the art, cross-linkers having a high percentage content of poorly-accessible SiH groups; examples of such cross-linking agents are those available commercially under the names Wacker® V24 or Wacker® V88.

In a preferred embodiment of the disclosure, the cross-linking agents can be present in the silicone mixture in a total quantity comprised between 0.5% and 2.5% by weight on the total weight of the mixture.

The apolar organic solvents present in the mixture used in the disclosure are selected from among those having a boiling point comprised between 50° C. and 120° C. and vapor pressure comprised between 2 and 30 kPa, measured at 20° C.

In a preferred embodiment, such apolar organic solvents can be selected independently from the group constituted by aromatic hydrocarbons having from 6 to 15 carbon atoms, preferably from 6 to 10 carbon atoms, linear or branched chain alkanes having from 6 to 15 carbon atoms, preferably from 6 to 10 carbon atoms, linear or branched chain ketones having from 3 to 6 carbon atoms, preferably from 3 to 4 carbon atoms, and mixtures thereof.

In a preferred embodiment, the apolar organic solvent can be heptane. In another preferred embodiment, the apolar organic solvent can be methyl-ethyl-ketone.

In another preferred embodiment, the apolar organic solvent can be a mixture of heptane and methyl-ethyl-ketone.

In a preferred embodiment of the disclosure, the apolar organic solvents can be present in the silicone mixture in a total quantity comprised between 70% and 90% by weight on the total weight of the mixture.

According to the method of the disclosure, after the step of spreading the silicone mixture, the PET film is subjected to a temperature comprised between 20° C. and 70° C. for a time comprised between 1 and 15 seconds.

Under these conditions of temperature and time, the apolar organic solvents evaporate from the silicone mixture spread on the PET film, in so doing preventing hazardous explosions from occurring in the subsequent step of lateral stretching, which is carried out at temperatures comprised between 80° C. and 110° C.

The role of the catalytic platinum (II) in complexed form present in the silicone mixture is to act as a catalyst of the addition reaction that leads to the polymerization of the silicones.

The platinum (II) is active in the catalysis; however, it carries out its action in complexed form, since the complexes make it stable in the mixture.

Therefore, in the context of the present disclosure the term “catalyst” is used to refer to platinum (II) in complexed form, i.e. to complexes of platinum (II).

Furthermore, it should be understood that the quantities of platinum (II) indicated in ppm refer to catalytic platinum (II), i.e. to the active form, without taking account of complexes.

Preferably, the complexes of platinum (II) can be selected from among those which are soluble in the solvents used in the mixture.

Preferably, furthermore, such complexes of platinum (II) can be selected from those free of amines and sulfides.

Complexes of platinum (II) are inactive at temperatures lower than 50° C., while they carry out their catalytic activity at temperatures comprised between 50° C. and 120° C.

Catalytic platinum (II) can preferably be present in the silicone mixture (in the form of complexes, as explained previously) in quantities comprised between 40 ppm and 60 ppm.

More preferably, it can be present in the silicone mixture in a quantity equal to 60 ppm.

In an embodiment of the present disclosure, the silicone mixture can further comprise one or more inhibitors of the catalytic platinum (II) in complexed form, in a total quantity equal to or lower than 20% by weight on the total weight of the silicone mixture.

The presence of inhibitors of complexes of the platinum (II) offers another advantage on the practical level, by contributing to preventing the polymerization of the monomers and/or silicone prepolymers until the end of the lateral stretching step.

In fact, the heating of the PET film coated with the silicone mixture to the temperature of 80-110° C. in order to provide the lateral stretching activates the complexes of platinum (II), thus starting the polymerization reaction.

However, it is advisable to prevent the polymerization from occurring before the lateral stretching, in order to prevent the mechanical action of tensioning the PET film from causing the breakage of the layer of polymerized, and therefore rigid, silicone stuck to the surface of the film.

Such breakages in fact would leave surface areas of the PET film not covered by silicone and therefore not active in the release of adhesives, which is the task for which the film is intended.

In order to overcome this problem, it is possible to use reduced quantities of catalytic platinum (II) (not greater than 80 ppm) in the silicone mixture, or add inhibitors of complexes of platinum (II) to the silicone mixture.

Inhibitors of complexes of platinum (II) are molecules which are capable of interacting with such complexes, rendering them nonreactive to reagents and therefore inactive in polymerization.

In the presence of such inhibitors, therefore, the polymerization of silicones is substantially inhibited.

The inhibitors used in the silicone mixture have the characteristic of evaporating at temperatures comprised between 100° C. and 110° C.

Therefore, at the temperatures envisaged for the lateral stretching (80-110° C.), the inhibitors begin to evaporate, leaving the mixture and leaving the complexes of platinum (II) in active form: under such conditions the polymerization reaction is started.

In a preferred embodiment, the inhibitors of complexes of platinum (II) can be present in the silicone mixture in a total quantity that is equal to or lower than 10% by weight on the total weight of the silicone mixture. In an even more preferred embodiment, such inhibitors can be present in the silicone mixture in a total quantity that is equal to or lower than 5% by weight on the total weight of the silicone mixture.

In another preferred embodiment, the inhibitors used in the present disclosure can be organic acid esters, more preferably maleate esters.

When the silicone mixture comprises the one or more inhibitors of complexes of platinum (II), the total quantity of catalytic platinum (II) present in the mixture can be increased, up to a maximum of 120 ppm.

As mentioned, the alternative to the addition of the inhibitors of complexes of platinum (II) in the silicone mixture is the use of a quantity of catalytic platinum (II) not greater than 80 ppm.

In an embodiment in which the silicone mixture does not comprise inhibitors of complexes of platinum (II), in addition to using catalytic platinum (II) in a quantity not exceeding 80 ppm, it is possible to use poorly-reactive cross-linkers, such as Wacker® V24 or Wacker® V88.

In a preferred embodiment, it is possible to use the Wacker® V24 cross-linker with a quantity of catalytic platinum (II) of 65 ppm at most.

In another preferred embodiment, it is possible to use the Wacker® V88 cross-linker with a quantity of catalytic platinum (II) of 60 ppm at most, more preferably of 50 ppm at most.

In both of the cases described, both in the presence and in the absence of the inhibitors of complexes of platinum (II), the quantities of catalytic platinum (II) used in the present disclosure are lower than those commonly used in the state of the art in order to obtain a complete polymerization of the monomers and/or silicone prepolymers (i.e. 100-150 ppm, typically 120 ppm).

This depends on the fact that complete polymerization of the silicones occurs in the step of thermal stabilization of the PET, in which the operating temperatures are comprised between 170° C. and 280° C.

Since high temperatures, as is known, increase the speed of the polymerization reaction, the quantity of catalyst used can be reduced, with consequent advantage in terms of savings.

In addition to the components cited and discussed above, the silicone mixture can also optionally comprise one or more adhesion promoters, i.e. molecules capable of modifying the separation capacity of the silicone after the polymerization.

The adhesion promoters used in the disclosure are silicone additives such as, for example, methoxy-siloxanes, methoxy-silanes, functionalized silanes, acetyl-siloxanes and mixtures thereof.

In a preferred embodiment of the disclosure, the adhesion promoters can be present in the silicone mixture in a quantity equal to or lower than 5% by weight on the total weight of the mixture. More preferably, the adhesion promoters can be present in the silicone mixture in a quantity equal to or lower than 2.5% by weight on the total weight of the mixture.

Summing up, therefore, the method of the disclosure is comprised in the following steps:

(i) longitudinal stretching of a casting of melted PET: at the end of this step a film is obtained that has been stretched in the longitudinal direction;

(ii) cooling to ambient temperature of the longitudinally-stretched film obtained in step (i);

(iii) spreading, on the cooled film, a silicone mixture that comprises: (a) one or more monomers and/or one or more silicone prepolymers, (b) one or more apolar organic solvents having a boiling point comprised between 50° C. and 120° C. and a vapor pressure comprised between 2 and 30 kPa, measured at 20° C., (c) one or more cross-linking agents, (d) catalytic platinum (II) in complexed form;

(iv) heating the PET film coated with the silicone mixture to a temperature comprised between 20° C. and 70° C. for a time comprised between 1 and 15 seconds: this step removes the apolar organic solvents before the lateral stretching, which requires temperatures at which such solvents could explode;

(v) lateral stretching (perpendicular to the longitudinal stretching): at the end of this step a siliconized film is obtained that has been stretched both in the longitudinal direction and in the lateral direction. During this step the catalysts are activated;

(vi) bringing the film obtained in step (iv) to temperatures comprised between 170° C. and 280° C. for a time comprised between 3 and 30 seconds: in this step the polymerization of the silicones is completed and, simultaneously, the PET crystallizes, becoming thermally stable;

(vii) cooling the thermally stabilized film to ambient temperature.

Although some particular applications of silicone-treated films can require a spreading of silicone mixture in a quantity comprised between 0.15 and 10 g/m² of film, usually the silicone mixture is spread on the surface of the longitudinally-stretched PET film in a quantity comprised between 4 and 6 g/m² of film. The spreading of such quantity of fresh mixture would obtain a maximum basis weight of the layer of silicones after drying which is comprised between 0.3 and 1.2 g/m² of film

However, the lateral stretching entails a transverse lengthening of the film, with respect to the original dimensions, of approximately 3.3 times and a reduction of approximately 3.3 times both of the thickness of the PET film, and of the thickness of the applied layer of silicones.

Therefore, the maximum basis weight of the layer of silicones on the end product, after the lateral stretching, is comprised between 0.1 and 0.4 g/m² of film

The method of the disclosure can be carried out using the systems commonly known and used in the state of the art for the extrusion of PET films and spreading them with silicone mixtures: for example, the spreading of the silicone mixture can be carried out with a rotogravure cylinder, with a specific volume of the spreading cylinder comprised between 6 and 30 g/cm³, preferably comprised between 6 and 15.5 g/cm³, and even more preferably comprised between 8.5 and 15.5 g/cm³.

In practice it has been found that the method of the disclosure fully achieves these advantages and features. In particular, the method of the disclosure makes it possible to prepare “in-line” silicone-treated PET films having different chemical-physical properties according to the nature of the silicones used, an important characteristic in order to obtain the desired controlled release for each type of adhesive.

This result is obtained thanks to the use of apolar organic solvents in the silicone mixture, which are capable of solubilizing silicones (in the form of monomers and/or silicone prepolymers) of different chemical types (therefore having different chemical-physical properties).

In turn, the use of apolar organic solvents is made possible by the provision of a step of heating the PET film coated with the silicone mixture to a temperature of 20-70° C. for a time comprised between 1 and 15 seconds, combined with a suitable choice of apolar organic solvents having a boiling point comprised between 50° C. and 120° C. and a vapor pressure comprised between 2 and 30 kPa, measured at 20° C.

Furthermore, the method of the present disclosure is advantageous in that, by carrying out the silicone treatment “in-line”, it ensures that the step of silicone treatment occurs prior to the step of lateral stretching (therefore prior to the thermal stabilization of the film)

The fact that the film is subjected to thermal stabilization after having been siliconized ensures a better anchoring of the layer of silicones to the PET surface.

In addition, since the lateral stretching triples the lateral dimensions of the film, applying the silicone mixture on the film prior to such step (which is what occurs in the “in-line” approach) offers an undoubted advantage in terms of rapidity and ease of application, in that it makes it possible to work on a smaller support.

The method, thus conceived, is susceptible of numerous modifications and variations, all of which are within the scope of the appended claims Moreover, all the details may be substituted by other, equivalent elements, the correspondence of which is known to the person skilled in the art.

### EXAMPLES

Hereinafter two examples are given of the “in-line” silicone treatment method according to the disclosure.

| Characteristics of the method | Example 1 | | Example 2 | |
|---|---|---|---|---|
| Spreading system | Rotogravure | | Rotogravure | |
| | cylinder | | cylinder | |
| Specific volume of | 9 | g/cm³ | 9 | g/cm³ |
| spreading cylinder | | | | |
| Line speed | 200 | m/min | 200 | m/min |
| Rotogravure speed | 200/250 | m/min | 200/200 | m/min |

| | | |
|---|---|---|
| Type of rotation of | Same direction | Same direction |
| spreading cylinder | of rotation with | of rotation with |
| | respect to the | respect to the |
| | direction of travel | direction of travel |
| | of the film | of the film |
| Surface treatment of the | Corona | Corona |
| film prior to the spreading | treatment | treatment |

| Characteristics of the silicone mixture | Example 1 | | Example 2 | |
|---|---|---|---|---|
| Heptane | 30 | kg | 40 | kg |
| Isopropyl alcohol | 2 | kg | 2 | kg |
| Methyl-ethyl-ketone | 6 | kg | 8 | kg |
| Adhesion promoter Wacker ® | 18.1 | kg | 18.1 | kg |
| Dehesive ® 953 | | | | |
| Adhesion promoter HF 86 | 0.2 | kg | 0.2 | kg |
| Wacker ® V88 cross-linker | 0.095 | kg | 0.095 | kg |
| Complex of platinum (II) Wacker ® | 0.060 | kg | 0.046 | kg |
| Catalyst OL | | | | |
| Inhibitor of complex of platinum | 0.09 | kg | 0 | kg |
| (II) (ethoxy-propyl-maleate) | | | | |
| Dry (with respect to the solvents) | 17.8% | p/p | 14.7% | p/p |
| Catalytic platinum (II) (active) | 66 | ppm | 50 | ppm |
| Basis weight of the fresh deposit of | 4.10 | g/m² | 3.88 | g/m² |
| silicone mixture | | | | |
| Basis weight of the dry silicone layer | 0.73 | g/m² | 0.57 | g/m² |

The two formulations given for the purposes of example for the silicone mixture have the chemical-physical characteristics described in the text of the present application.

The cross-linker (of the Wacker® V88 type) has an active content of SiH groups comprised between 1.2 and 1.45 and averagely fast reaction kinetics in linking the vinyl groups present on the monomers and/or silicone prepolymers.

The concentration of catalytic platinum (II) is decidedly lower than the 120 ppm normally used during standard polymerization reactions.

Furthermore the spreading system with rotogravure cylinder makes it possible to apply a silicone later on the longitudinally-stretched PET film, the basis weight of which after drying (i.e. dry) is comprised between 0.5 and 0.8 g/m².

Once the lateral stretching has also been done, the resulting PET film will have a coating of silicone the basis weight of which is comprised between 0.15 and 0.3 g/m², ideal values for the applications for which silicone-treated films prepared with the method of the disclosure are intended.

For a siliconized PET film to possess stable separating capabilities from adhesive supports, the silicone layer must in fact have a thickness comprised between 0.05 and 0.5 g/m².

The disclosures in Italian Patent Application No. MI2015A000550 (102015902344627) from which this application claims priority are incorporated herein by reference.

1-15. (canceled)

16. A method for preparing silicone-treated films of polyethylene terephthalate (PET), in which the silicone treatment occurs simultaneously with the extrusion of the films, the method including the following steps:
(i) longitudinal stretching of a casting of melted PET;
(ii) cooling to ambient temperature of the film obtained in step (i);
(iii) spreading, on the cooled film, a silicone mixture;
(iv) heating the PET film coated with the silicone mixture to a temperature comprised between 20° C. and 70° C. for a time comprised between 1 and 15 seconds;
(v) lateral stretching of the PET film obtained in step (iv);
(vi) heating of the film obtained in step (v) to temperatures comprised between 170° C. and 280° C. for a time comprised between 3 and 30 seconds;
(vii) cooling of the film obtained in step (vi) down to ambient temperature;
wherein the silicone mixture comprises:
(a) from 1% to 50% by weight on the total weight of the mixture, of one or more monomers and/or one or more silicone prepolymers;
(b) from 50% to 95% by weight on the total weight of the mixture, of one or more apolar organic solvents having a boiling point comprised between 50° C. and 120° C. and a vapor pressure comprised between 2 and 30 kPa, measured at 20° C.;
(c) from 0.1% to 5% by weight on the total weight of the mixture, of one or more cross-linking agents; and
(d) from 40 to 80 ppm of catalytic platinum (II), in which said catalytic platinum (II) is in complexed form.

17. The method according to claim 16, wherein the one or more monomers and/or one or more silicone prepolymers present in the silicone mixture are selected independently from the group constituted by methyl-siloxanes, dimethyl-siloxanes and multiples thereof, with side chains of length comprised between 1 and 10 carbon atoms, and mixtures thereof.

18. The method according to claim 16, wherein the one or more monomers and/or one or more silicone prepolymers present in the silicone mixture have one or more vinyl groups on the side chains.

19. The method according to claim 16, wherein the one or more apolar organic solvents having a boiling point comprised between 50° C. and 120° C. and a vapor pressure comprised between 2 and 30 kPa, measured at 20° C., present in the silicone mixture are selected independently from the group constituted by aromatic hydrocarbons having from 6 to 15 carbon atoms, linear or branched chain alkanes having from 6 to 15 carbon atoms, linear or branched chain ketones having from 3 to 6 carbon atoms, and mixtures thereof.

20. The method according to claim 19, wherein the apolar organic solvent having a boiling point comprised between 50° C. and 120° C. and a vapor pressure comprised between 2 and 30 kPa, measured at 20° C., present in the silicone mixture is selected from the group constituted by heptane, methyl-ethyl-ketone, and a mixture of heptane and methyl-ethyl-ketone.

21. The method according to claim 16, wherein the one or more monomers and/or the one or more silicone prepolymers are present in the silicone mixture in a total quantity comprised between 5% and 30% by weight on the total weight of the mixture.

22. The method according to claim 16, wherein the one or more apolar organic solvents having a boiling point comprised between 50° C. and 120° C. and a vapor pressure comprised between 2 and 30 kPa, measured at 20° C., are present in the silicone mixture in a total quantity comprised between 70% and 90% by weight on the total weight of the mixture.

23. The method according to claim 16, wherein the one or more cross-linking agents are present in the silicone mixture in a total quantity comprised between 0.5% and 2.5% by weight on the total weight of the mixture.

24. The method according to claim 16, wherein the silicone mixture comprises further one or more inhibitors of catalytic platinum (II) in complexed form, in a total quantity equal to or lower than 20% by weight on the total weight of the mixture.

25. The method according to claim 24, wherein the one or more inhibitors of catalytic platinum (II) in complexed form are present in the silicone mixture in a total quantity equal to or lower than 10% by weight on the total weight of the mixture.

26. The method according to claim 24, wherein the one or more inhibitors of catalytic platinum (II) in complexed form are selected independently from the group constituted by organic acid esters.

27. The method according to claim 16, wherein the silicone mixture comprises catalytic platinum (II) in complexed form up to a maximum of 120 ppm.

28. The method according to claim 16, wherein the silicone mixture comprises further one or more adhesion promoters.

29. The method according to claim 28, wherein the one or more adhesion promoters are silicone additives selected independently from the group constituted by methoxy-siloxanes, methoxy-silanes, functionalized silanes, acetyl-siloxanes and mixtures thereof.

30. The method according to claim 28, wherein the adhesion promoters are present in the silicone mixture in a total quantity equal to or lower than 5% by weight on the total weight of the mixture.
